(19) United States
(12) Patent Application Publication
(10) Pub. No.: US 2006/0048064 A1
(43) Pub. Date: Mar. 2, 2006

(54) Ambient display of data in a user interface

(75) Inventor: David Vronay, Beijing (CN)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 10/930,169

(22) Filed: Aug. 31, 2004

(51) Int. Cl. G06F 9/00

(52) U.S. Cl. 715/764; 715/772

(57) ABSTRACT

An ambient display of data in a user interface is described. In an implementation, a method includes generating a first representation of a plurality of events for output in a user interface. A second representation of one or more additional events is generated such that a change made in a display characteristic from the first representation to the second representation complies with a just-noticeable threshold.

### TECHNICAL FIELD

The present invention generally relates to the field of user interfaces and more particularly relates to an ambient display of data in a user interface.

### BACKGROUND

The computing device has become the center of personal communications for a user. For example, the user may utilize the computing device to receive emails, instant messages, and voice mails as well as engage in telephone conversations and video conferencing. Thus, the user may utilize a wide variety of techniques to receive and transmit communications utilizing the computing device. Additionally, each of these techniques may be utilized to receive a vast number of communications. For example, the user may receive a large number of emails, voice mails, instant messages, and so on during the course of a typical day.

The computing device may also be the central tool utilized by the user to perform work-related tasks, such as to create documents, spreadsheets, and so on. Communications received by the computing device, however, may interrupt the user's operation of the computing device when performing the tasks, and consequently hinder the user's ability to perform the tasks while simultaneously receiving notifications of the communications. For example, a user may utilize a word processor on the computing device to generate a document. While generating the document, the user may also receive notifications of communications that are also being received by the computing device, such as emails and instant messages. Typical notifications that are provided for these communications, however, distract the user when performing the tasks, such as generating the document. Therefore, the user is forced to make a cognitive switch from generating the document to viewing the notifications.

Accordingly, there is a continuing need for improved techniques for display of communication and other data in a user interface.

### SUMMARY

An ambient display of data in a user interface is described. In an implementation, the ambient display does not require the user's constant cognitive attention but does allow the user to notice trends in data being received by the computing device. For example, the ambient display may represent events (e.g., communications) received in data streamed to the client. Each representation of the events in the ambient display may be provided so that the user does not notice individual changes to the representation, but a plurality of such changes are noticeable by the user as a trend.

The user, for instance, may receive a plurality of emails, which are each represented by one or more representations, such as icons, portions of a display area, objects in a screen saver, and so on. Changes to the representations may be governed by a just-noticeable threshold so that the individual changes are not separately noticeable by the user. For example, the just-noticeable threshold may describe a rate of change that may be employed for colors of a representation so that incremental changes made to the color of a representation that comply with the just-noticeable threshold are not noticeable by the user. The user, however, may notice a plurality of such changes which indicate a trend characterized by the plurality of events, such as to notice that a greater number of communications were received over a corresponding period of time than received over a previous period of time. Thus, the ambient display may allow the user to see incoming new messages, communication patterns and volume of messages by glancing at the ambient display and without the constant cognitive attention previously required.

### BRIEF DESCRIPTION OF THE DRAWINGS

FIG. 1 is an illustration of an environment in an exemplary implementation that is operable to employ an ambient display of data.

FIG. 2 is an illustration of an exemplary implementation showing processing of streaming data by an ambient display module of FIG. 1 to generate an ambient display having representations of the streaming data that comply with a just-noticeable threshold.

FIG. 3 is an illustration of a user interface in an exemplary implementation configured to show a communication history arranged according to a contact which sent or received the communication.

FIG. 4 is an illustration of a user interface in an exemplary implementation showing a communication history arranged according to a technique utilized to send or receive the communication.

FIG. 5 is an illustration of a user interface in an exemplary implementation provided by switching the user interface of FIG. 4 into a screensaver mode.

FIG. 6 is an illustration of a user interface in an exemplary implementation showing representations arranged in a radial manner.

FIG. 7 is an illustration of an exemplary implementation showing a plurality of representations for display over a corresponding period of time.

FIG. 8 is an illustration of a system in an exemplary implementation in which a user interface having an ambient display of representations of events is depicted as an island scene on the display device.

FIG. 9 is a flow diagram depicting a procedure in an exemplary implementation in which first and second representations are generated for successive output in a user interface to provide an ambient display.

FIG. 10 is a flow diagram depicting a procedure in an exemplary implementation in which a second representation, for output in succession after a first representation, has a display characteristic adjusted for compliance with a just-noticeable threshold.

FIG. 11 is a flow diagram depicting a procedure in an exemplary implementation in which streaming data having events that occur at a first rate are represented by successive representations displayed in an ambient display at a second rate which does not match the first rate.

The same reference numbers are utilized in instances in the discussion to reference like structures and components.

### DETAILED DESCRIPTION

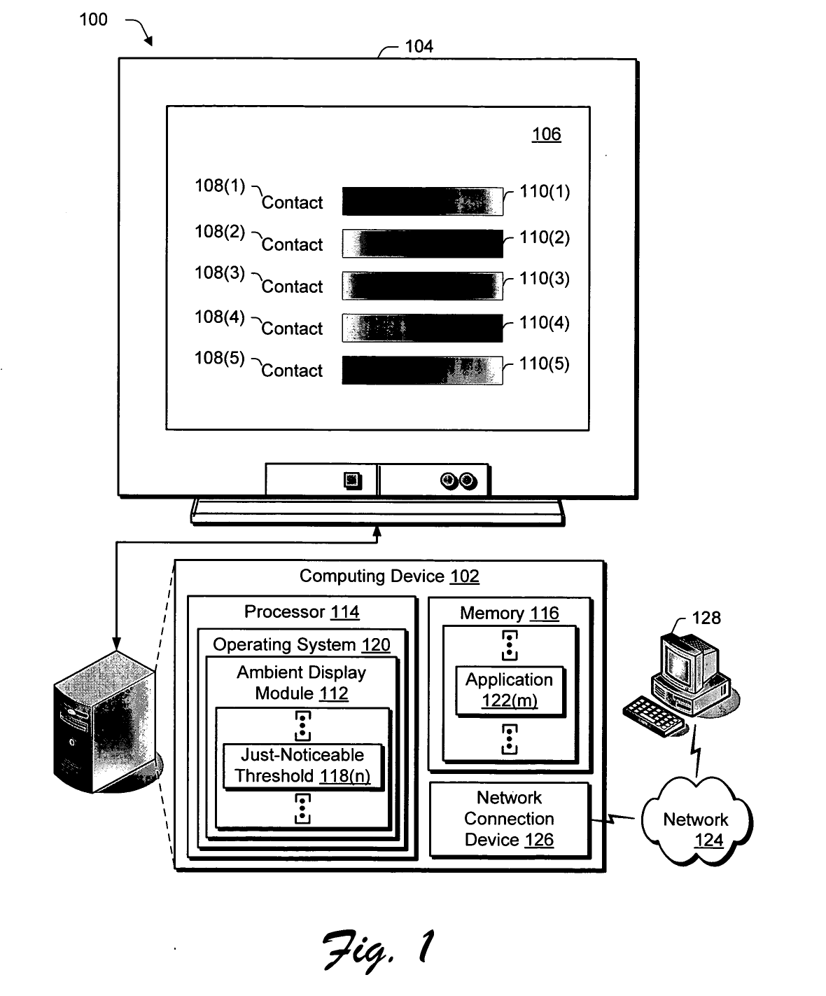

FIG. 1 is an illustration of an environment 100 operable to provide a user interface having an ambient display. The environment 100 is illustrated as having a computing device 102 that is communicatively coupled to a display device 104 for display of a user interface 106. The illustrated user interface 106 provides a communications history of a plurality of contacts 108(1)-108(5). Each of the plurality of contacts 108(1)-108(5) corresponds to one a plurality of representations 110(1)-110(5). Each of the plurality of representations 110(1)-110(5) represents a history of communications received by the computing device 102 from the corresponding one of the plurality of contacts 108(1)-108(5). Reference numbers are utilized in the illustration of the user interface 106 in FIG. 1 to show correspondence of components, such as contact 108(1) with representation 110(1), and so on.

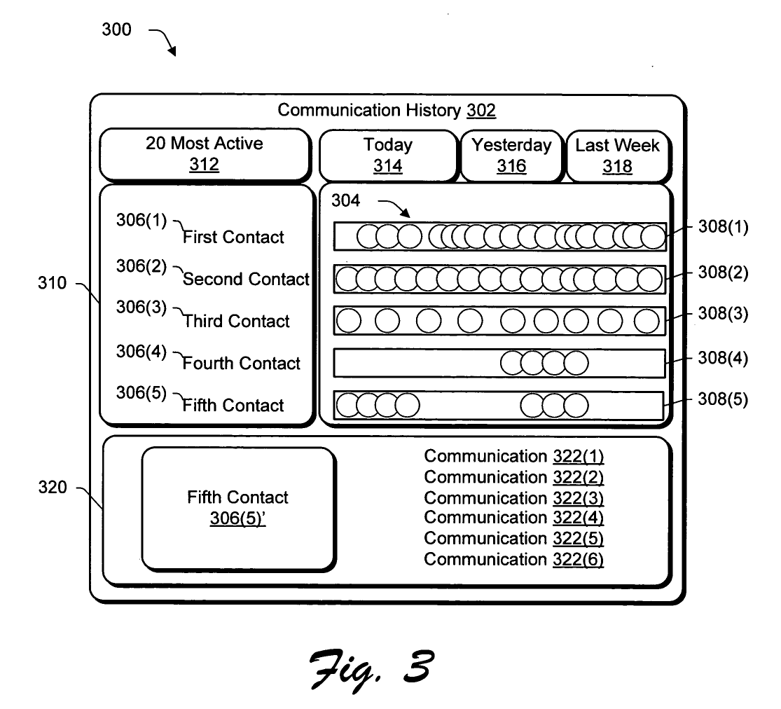

The plurality of representations 110(1)-110(5) are illustrated in FIG. 1 as gradients, although a variety of other representations may also be utilized as will be described in greater detail beginning in relation to FIG. 3. Each of the representations 110(1)-110(5) represents a period of time, with the most recent time being depicted by the left of the representations 110(1)-110(5) of FIG. 1. A display characteristic (in this instance differing intensities, e.g., shades, of gray) is utilized to indicate a relative number of communications received at different points in time represented by the representations 110(1)-110(5). Representations 110(1), 110(5), for instance, utilize dark shades of gray that progress to lighter shades of gray to indicate that a greater number of communications were received in a recent point in time than were received at previous points in time. Likewise, representations 110(1), 110(5) utilize light shades of gray that progress to darker shade of gray to indicate that a lesser number of communications were received in a recent point in time than were received at previous points in time. Representation 110(3) indicates a “middle” scenario in which a greater number of communications were received at a central point in time in the period of time described by the representation 110(3). Thus, the shades of gray indicate relative numbers of communications received during the respective points in time.

The plurality of representations 110(1)-110(5) are generated by an ambient display module 112, which is illustrated as being executed on a processor 114 and is storable in memory 116 (i.e., computer readable storage media). The ambient display module 112 is illustrated as including one or more of a plurality of just-noticeable thresholds 118(n), where “n” can be any integer from one to “N”. In another implementation, the plurality of just-noticeable thresholds 118(n) is separately storable in memory 116 apart from the ambient display module 112 and is callable by the ambient display module 112.

The plurality of just-noticeable thresholds 118(n) define changes that may be made to display characteristics of the representations 110(1)-110(5) to provide an ambient display. For example, one or more of the just-noticeable thresholds 118(n) may define a rate of range in a color, dimension, intensity, movement, texture, and so on. Although changes to visual display characteristics are described, the display characteristics may include any sensory display, such as temperature, sounds, and so on. Changes made to the display characteristics of the plurality of representations 110(1)-110(5) that are bounded (i.e., within) the corresponding just-noticeable threshold 118(n) provide an ambient display. For instance, the just-noticeable thresholds 118(n) may be defined such that individual changes to the display characteristics of the plurality of representations 110(1)-110(5) are not noticeable by the user, but a plurality of such changes are noticeable to indicate a trend. For example, a change may be made by the ambient display module 112 to darken a representation. The change by itself, however, may not be noticeable by the user. In spite of this, a plurality of such changes may be noticeable by the user as a trend, e.g., a progressive darkening of the representation made over a period of time. Such changes may be made in a manner that is similar to a rising temperature of a room, in which individual incremental changes (e.g., by degree) are not noticeable by the user, but the user does eventually notice that the room has a higher temperature than before. Likewise, display characteristics may be changed such that individual changes are not noticeable but a sum of a plurality of such changes is noticeable as a trend, such as getting darker, lighter, different colors, movement, larger, smaller, and so on.

The ambient display module 112 may accept data from a variety of sources for providing an ambient display of data in the user interface 106. The ambient display module 112, for instance, is illustrated in the environment 100 of FIG. 1 as being included in an operating system 120. The operating system 120 is software (which may be provided by one or more modules) that controls the allocation and usage of hardware resources of the computing device 102, such as memory 116, processor 114, peripheral devices (e.g., the display device 104), and so on. The operating system 120 is foundation software on which programs, such as word processors, spreadsheets, browsers, and so on, may employ to access the hardware resources. For instance, the computing device 120 may include a plurality of applications 122(m), where “m” can be any integer from one through “M”, which are illustrated as stored in memory 116 and are executable on the processor 114. Each of the plurality of applications 122(m) is executable to provide a plurality of events for processing by the ambient display module 112. Therefore, the plurality of applications 122(m) may provide the plurality of events to the ambient display module 112, through the operating system 120, to cause the plurality of events to be rendered in the user interface 106 as one or more representations 110(1)-110(5). Thus, the ambient display module 112 may provide one or more application programming interfaces (APIs) which “hide” the details of generating the representations 110(1)-110(5) from the applications 122(m).

In another implementation, the ambient display module 112 is implemented as part of the applications 122(m) themselves and is separate from the operating system 120. For example, application 122(m) may be configured to include an address book module that provides a user interface having contacts 108(1)-108(5) from the address book and corresponding representations 110(1)-110(5) of a respective communication history of the respective contacts 108(1)-108(5). In a further implementation, the ambient display module 112 is a stand-alone module.

The ambient display module 112 may also receive data from over a network 124. For example, the computing device 102 may include a network connection device 126 for communicatively coupling the computing device 102 with another computing device 128, such as a web server, a remote computing device, and so on. Application 122(m), for instance, may be executable on the processor 114 to receive stock quotes from over the network 124. The application 122(m) may then provide the stock quotes to the ambient display module 112 for display in the user interface 106 as one or more representations. Although the network 124 is illustrated as the Internet, the network 124 may assume a wide variety of configurations. For example, the network 124 may include a wide area network (WAN), a local area network (LAN), a wireless network, a public telephone network, an intranet, and so on. Further, although a single network 124 is shown, the network 124 may be configured to include multiple networks.

Additionally, although the computing device 102 is illustrated as a desktop personal computer (PC), the computing device 102 may be configured in a variety of ways, such as a set-top box, a notebook computer, a tablet PC, a personal digital assistance (PDA), an information appliance, a game console, a wireless phone, and so on. The computing device 102 may range from a full resource device with substantial memory and processor resources (e.g., PCs, television recorders equipped with hard disk) to a low-resource device with limited memory and/or processing resources (e.g., traditional set-top boxes). Although the display device 104 is illustrated as separate from the computing device 102, in another implementation the computing device 102 includes the display device 104, such as a wireless phone, a television having an integrated set-top box, and so forth.

As previously described, the computing device 102 includes the processor 114 and memory 116 (e.g., a computer-readable storage media). The processor 114 is not limited by the materials from which it is formed or the processing mechanisms employed therein. For example, the processor 114 may be formed from semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth. Additionally, although a single memory 116 is shown, a wide variety of types and combinations of memory may be employed, such as random access memory (RAM), hard disk memory, removable medium memory, and so forth.

Generally, any of the functions described herein can be implemented using software, firmware (e.g., fixed logic circuitry), manual processing, or a combination of these implementations. The terms “module,” “functionality,” and “logic” as used herein generally represent software, firmware, or a combination of software and firmware. In the case of a software implementation, the module, functionality, or logic represents program code that performs specified tasks when executed on a processor (e.g., CPU or CPUs). The program code can be stored in one or more computer readable memory devices, such as the memory 116 as previously described. The features of the ambient display described herein are platform-independent, meaning that the ambient display strategies may be implemented on a variety of commercial computing platforms having a variety of processors.

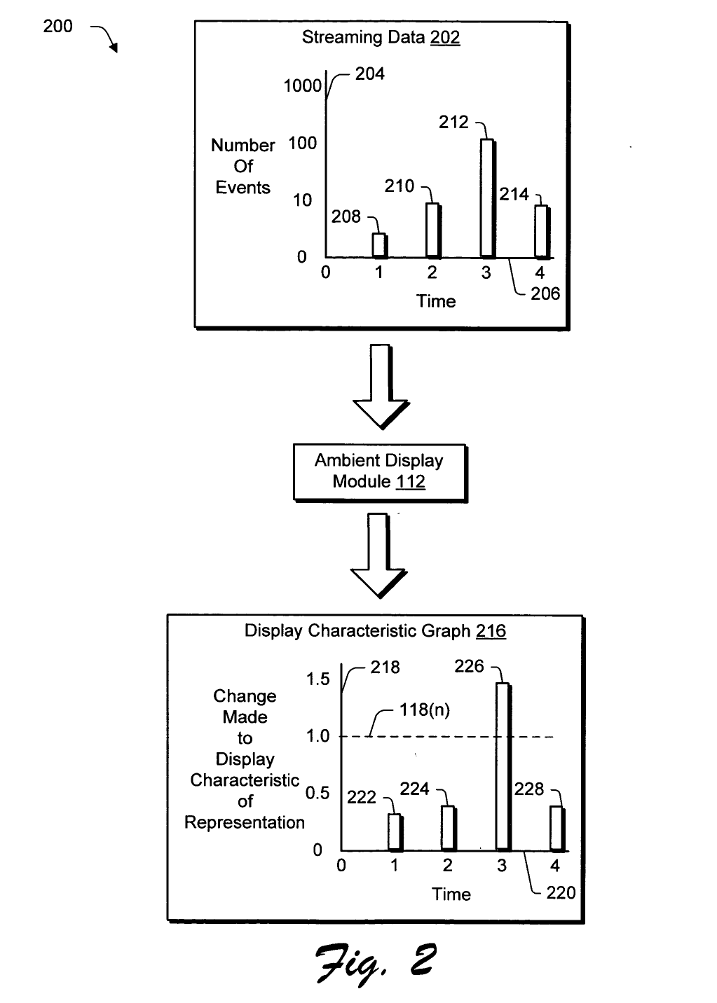

FIG. 2 is an illustration of an exemplary implementation 200 showing processing of streaming data 202 by the ambient display module 112 of FIG. 1 to generate an ambient display having representations of the streaming data 202 that comply with the just-noticeable threshold 118(n). As previously described, the ambient display module 112 may receive the streaming data 202 from a variety of sources, such as locally from the applications 122(m) of FIG. 1, remotely from over the network 124, and so on.

The streaming data 202 is represented by a graph having a first axis 204 which depicts a number of items described in the streaming data 202 and a second axis 206 which describes different periods in time. As illustrated, the streaming data 202 describes approximately five events that occurred during the time period from “0” to “1”, ten events that occurred during the time period from “1” to “2”, one-hundred events that occurred during the time period from “2” to “3”, and ten events that occurred during the time period from “3” to “4”, which are illustrated respectively by bars 208, 210, 212, 214. Events may be defined in a wide variety of ways, such as number of emails, stock ticker information (e.g., points in an industrial average), and so on.

To generate representations of the streaming data for inclusion in an ambient display, the ambient display module 112 generates the representations of the events such that it complies with the just-noticeable threshold 118(n) for a display characteristic. For example, the ambient display module 112 may make a change to a dimension of a representation based on the number of events described in the streaming data 202 during a corresponding period of time. The computed changes for the display characteristic are shown by a display characteristic graph 216 of FIG. 2.

The display characteristic graph 216 depicts changes made to the display characteristic as a percentage of the change allowed by the just-noticeable threshold 118(n). For instance, the display characteristic graph 216 includes a first axis 218 which depicts a percentage of change which may be made during a corresponding period of time defined by a second axis 220 as defined by the just-noticeable threshold 118(n). A maximum change that may be made that complies with the just-noticeable threshold 118(n) is illustrated as a dashed-line and as the percentage “1.0” of FIG. 2. Thus, in this instance, changes made “below” the dashed-line are bounded by the just-noticeable threshold 118(n) and therefore comply with the just-noticeable threshold.

In the illustrated implementation, the display characteristic graph 216 includes a plurality of bars 222-228 which each indicate a change to be made to the display characteristic as computed by the ambient display module 112. For example, the ambient display module 112, may utilize an algorithm (e.g., function “f”) to compute an amount of change (e.g., Amount_{change}) to be made to a display characteristic during a period of time (e.g., Time_{change}) based on a number of events (e.g., Events_{original}) that occurred during a period of time (e.g., Time_{original}), as shown in the following equation:
f(Events_{original}, Time_{original})=(Amount_{change}, Time_{change})
It should be noted that even though the time periods are illustrated as matching in FIG. 2, the time periods need not match as shown in the above equation. For instance, changes may be made to a representation over a period of time (e.g., duration) that does not match a period of time (e.g., duration) during which the events occurred. Exemplary results of such a computation are shown as bars 222, 224, 226, 228 that are positioned at corresponding times indicated by the second axis 220.

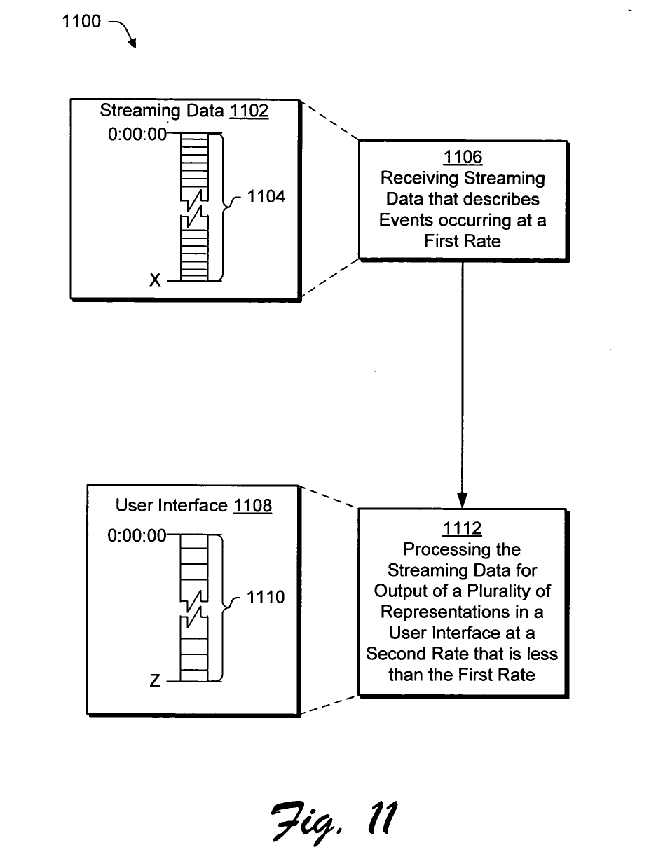

As shown by bars 222, 224 and 228, changes that were computed by the ambient display module 112 for the corresponding number of events (represented as bars 208, 210, 214) of the streaming data 202 fall within the just-noticeable threshold 118(n). Therefore, each of these changes, when made to a representation over a corresponding period of time, will not be separately noticeable by a user. Bar 226, however, indicates a change that exceeds the just-noticeable threshold 118(n). In other words, such a change to a display characteristic, if made, would be noticeable to the user. Therefore, the ambient display module 112 may be executed to limit the change indicated by bar 226 such that is falls within the just-noticeable threshold 118(n). In this way, the ambient display module 112 may utilized the just-noticeable threshold 118(n) to bound changes to be made to representations in a user interface such that the user interface provides an ambient display of the representations. Further discussion of the use of the just-noticeable threshold 118(n) to bound changes made to a display characteristic may be found in relation to FIG. 10.

Exemplary User Interfaces

The ambient display module 112 may be executed to generate representations of a wide variety of events for inclusion in a wide variety of user interfaces. Although the following figures show examples of user interfaces having representations of events in a communications setting, the ambient display module 112 may be executed in a wide variety of other settings.

FIG. 3 is an illustration of a user interface 300 in an exemplary implementation configured to show a communication history 302. The user interface 300 provides a spatial depiction of events, which in this instance are communications that were received or transmitted by the computing device 102 of FIG. 1. The user interface 300 includes a graph 304 having a horizontal axis which denotes “time” and a vertical axis for a plurality of contacts 306(1)-306(5), from which, communications are received. Each of the plurality of contacts 306(1)-306(1) has a corresponding one of a plurality of representations 308(1)-308(5) which denote communications that are received from the respective contacts 306(1)-306(5). In this implementation, each of the plurality of representations 308(1)-308(5) is illustrated as having circles, each circle denoting one or more communication that are received or transmitted by the computing device 102 of FIG. 1.

The user interface 300 allows a user to obtain a high-level overview of received communications without interacting (e.g., opening and/or reading) the actual communications. Thus, the user interface 300 may act as a status indicator which displays the communication history 302 for the user. The user interface 300 may also act as an initial navigational map which allows the user to graphically query individual communications by clicking on a respective circle in the representations 308(1)-308(5).

The user interface 300 includes a contact window 310 to display the names of the plurality of contacts 306(1)-306(5) and other identifying information, such as an “avatar” (i.e., a digital pictorial representation) of the respective contacts 306(1)-306(5). The contacts 306(1)-306(5) may be sorted based on various criteria, such as name, most recent communication received, most communications received, and so on. For example, the user may initiate a “20 Most Active” button 312 in the user interface 300 to display the twenty-most-active contacts. Contacts can also be “pinned” onto the contact window 310 such that even if the pinned contact does not constitute one of the top 20 active contacts, the pinned contact is still displayed.

The user interface 300 may also include headers which denote differing periods of times represented by the representations 308(1)-308(5). For example, the user interface 300 is illustrated as including headers for today 314, yesterday 316, and last week 318. Thus, the portions of the representations 308(1)-308(5) which are illustrated as “beneath” the headers for today 314, yesterday 316, and last week 318 describe communications which were received during that period, with the newest items represented on the left side of the user interface 300 and moving rightwards as time moves on. The user interface 300 may also be configured to automatically change the headers based on the period of time described by the representations. For instance, if the communication history 302 does not include recent messages, the headers may be changed to “this week”, “last month” and “last six months” to describe older communications.

Further, the user interface 300 may include a contact detail window 320. The contact detail window 320 includes another representation of the contact, which in this instance is fifth contact 306(5)′, and also shows a plurality of communications 322(1)-322(6) that have been received from and sent to that particular contact. The contact detail window 320 may be configured such that when the user positions a cursor over one of the plurality of contacts 306(1)-306(5), the corresponding contact (e.g., fifth contact 306(5)′) and the corresponding communications 322(1)-322(6) are displayed in the contact detail window 320.

The user interface 300 may also be configured such that one or more objects included in the communication history 302 are selectable such that the user may efficiently locate relevant information from the user interface 300. For example, the user may select one of the plurality of contacts 306(1)-306(5) as previously described to display corresponding communications in the contact detail window 320. In another example, each of the circles shown in the representations 308(1)-308(5) represents a corresponding communication. By selecting one of the circles, the corresponding contact 306(1)-306(5) (i.e., which either sent or received the communication) may be highlighted in the contact window 310 and the communications (e.g., communications 322(1)-322(6)) from that contact (e.g., contact 306(5)′) are displayed in the contact detail window 320. The particular communication that was selected may also be highlighted in the contact detail window 320. If clicked, the corresponding communication (e.g., document, log property for voice communication details, and so on) will be displayed for that communication.

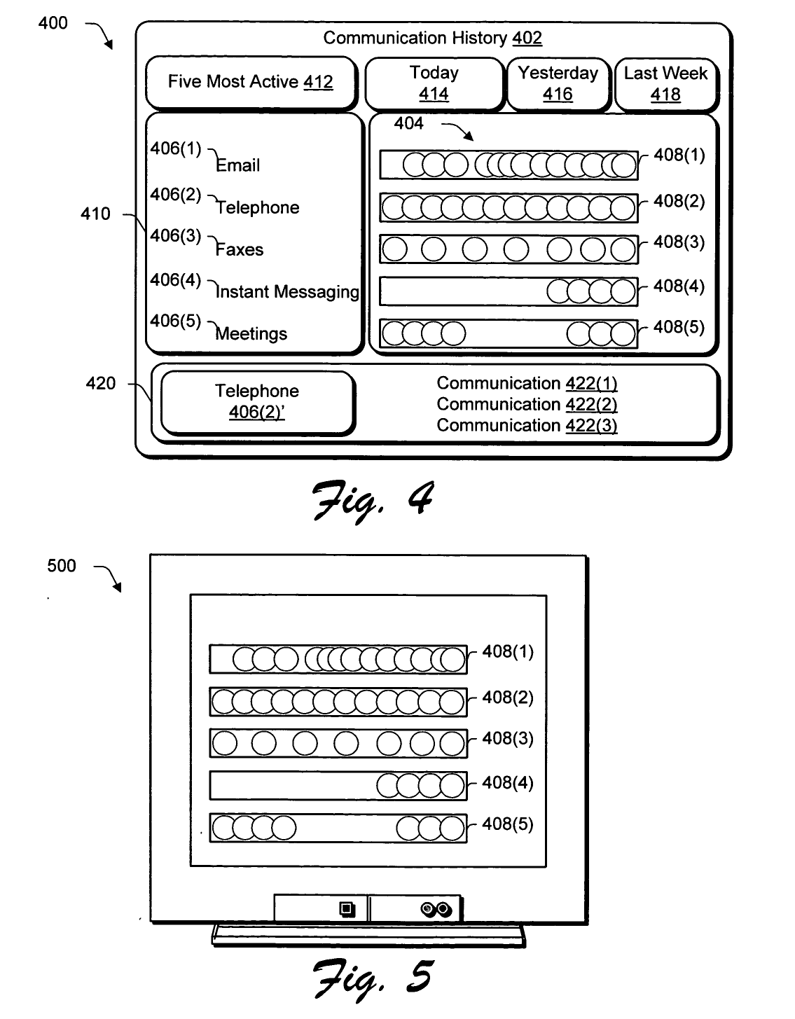

FIG. 4 is an illustration of a user interface 400 in an exemplary implementation showing a communication history 402 arranged according to a technique utilized to send or receive the communication. Like the user interface 300 of FIG. 3, the user interface 400 provides a spatial depiction of events, which in this instance are communications that were received or transmitted by the computing device 102 of FIG. 1 arranged according to the technique which was utilized to send or receive the communication.

The user interface 400 includes a graph 404 having a horizontal axis which denotes “time” and a vertical axis for a plurality of techniques, which are illustrated as email 406(1), telephone 406(2), faxes 406(3), instant messaging 406(4), and meeting 406(5). Each of the plurality of techniques has a corresponding one of a plurality of representations 408(1)-408(5) which denote communications that are received via the respective techniques. Like the plurality of representations 308(1)-308(5) of FIG. 3, the plurality of representations 408(1)-408(5) are illustrated as having circles, each circle denoting one or more communications that are received or transmitted by the computing device 102 of FIG. 1.

The user interface 400 may also include similar functionality as previously described for the user interface 300 of FIG. 3. For example, the user interface 400 may include a technique window 410 to display the names of the techniques utilized to interact with the communications. The user may initiate a “5 Most Active” button 412 to display the five most active techniques. Techniques can also be “pinned” onto the technique window 410.

The user interface 400 may also include headers, such as today 414, yesterday 416, and last week 418 for denoting respective points in time during which the communications that are illustrated “beneath” the headers were transmitted or received, such as today 414, yesterday 416, and last week 418.

The user interface 400 may further include a technique detail window 420 which displays another representation of the technique, which in this instance is telephone 406(2)′, and also shows a plurality of communications 422(1)-422(3) that have been received and sent using that particular technique. The user interface 400 may further include “selectable” functionality as previously described in relation to FIG. 3.

FIG. 5 is an illustration of a user interface 500 in an exemplary implementation provided by switching the user interface 400 of FIG. 4 into a screensaver mode. The user may cause the user interface 400 of FIG. 4 to enter the screensaver mode in a variety of ways. For example, the user may interact with the operating system 120 of FIG. 1 to set a condition such that when the computing device 102 does not receive an input from the user for “x” minutes, the ambient display module 112 will enter the screensaver mode for privacy.

The user interface 500 of FIG. 5 is illustrated as a version of the user interface 400 of FIG. 4, but with all text names and details obscured. In an implementation, the representations 408(1)-408(5) (and more particularly the circles of the representations 408(1)-408(5)) are partially obscured (e.g., blurred). The brackets representing the time period (illustrated as rectangles in FIG. 5) may still be seen, but without the corresponding indication of time periods as provided by the headers (e.g., today 414, yesterday 416, and last week 418) of the user interface 400 of FIG. 4.

Even though the textual descriptions and windows have been removed from the user interface 500, the user may still be aware of the correspondence of the representations with the corresponding platforms. For example, the user may utilize the user interface 400 over a prolonged period of time such that the user has memorized the correspondence between the techniques utilized to interact with the communications (e.g., email 406(1), faxes 406(2), and so on of FIG. 4) and the representations 408(1)-408(5). Therefore, the user may glance at the representations 408(1)-408(5) in the user interface 500 and instinctively know the corresponding technique from the user interface 400 of FIG. 4. In an implementation, the representations in the screensaver mode in the user interface 500 are not selectable to protect the corresponding communications from unauthorized access.

FIG. 6 is an illustration of a user interface 600 in an exemplary implementation showing representations arranged in a radial manner. The user interface 600 includes a radial graph 602 having a representation 604 of the user positioned in the middle of the graph. The circles in the radial graph 602 are representations of events that occurred over a period of time, with the newest events appearing in the center and moving outwards as time moves on. Accordingly, first and second dashed circles 606, 608 represent points in time that are progressively away. The circles in the radial graph 602 which represent the events may be color coded or shaped according to the type of event. For example, in the case of a communication, orange may be utilized to indicate incoming communications, blue utilized to indicate outgoing communications, red utilized to indicate urgent messages, and so on.

The user interface 600 may also include an event detail window 610 which describes one or more of the events represented (e.g., the circles) in the radial graph 602 in greater detail. For example, the user may select three of the circles in the radial graph 602, to cause information relating to the represented events to be shown in greater detail as events 612(1)-612(3) in the event detail window 610.

As previously described, each of the circles in the radial graph 602 represent an event for representation in the user interface 600. For example, circle 614 may provide a representation of an email received from the remote computing device 128 of FIG. 1. To display the circle 614 such than the user interface 600 provides an ambient display, a plurality of representations may be displayed in succession over a period of time such that the circle 614 is displayed according to a just-noticeable threshold, an example of which will be described in greater detail in relation to the following figure.

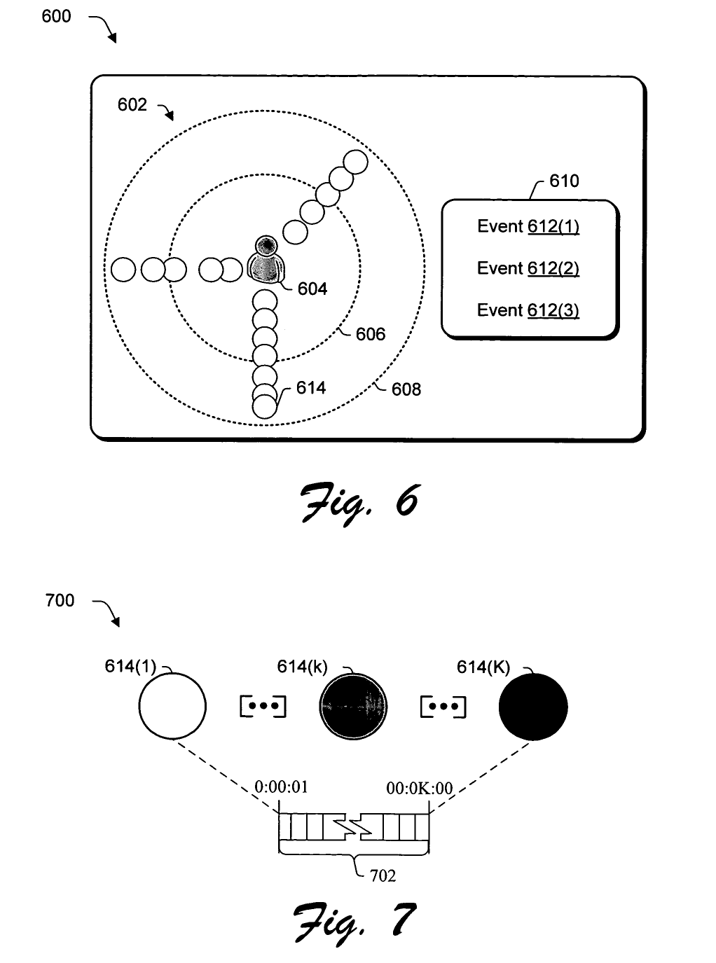

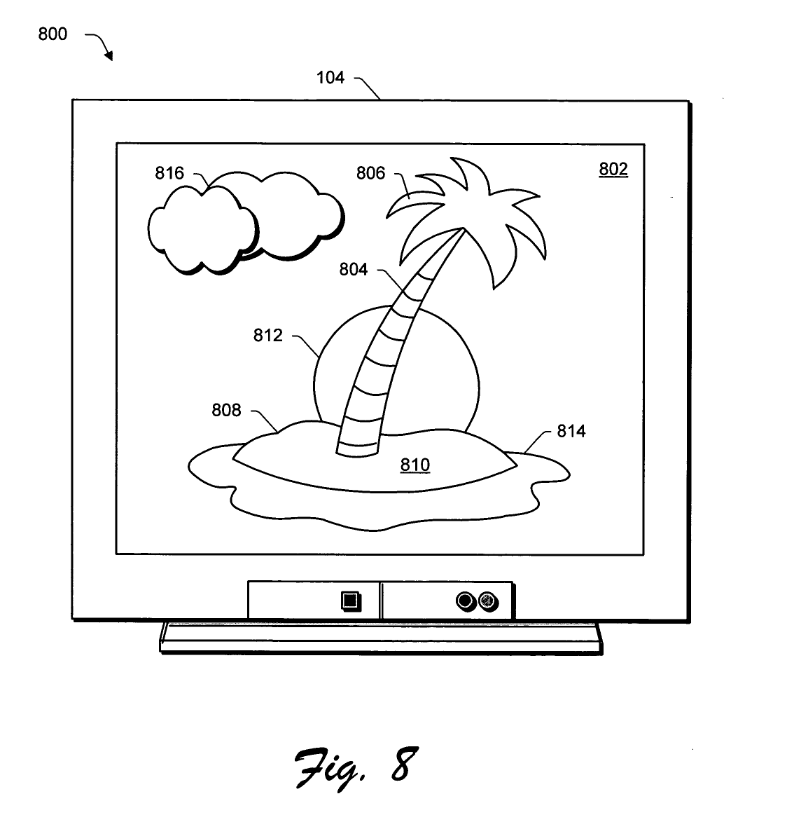

FIG. 7 is an illustration of an exemplary implementation 700 showing a plurality of representations 614(1), . . . , 614(k), . . . , 614(K) for display over a corresponding period of time 702. Each of the plurality of representations is for display during a period of time from “1” to “K”. As shown in FIG. 7, representation 614(1) is white, representation 614(k) is gray, and representation 614(K) is black.

The plurality of representations 614(1)-614(K), when displayed in succession over the corresponding period of time 702 from “1” to “K”, provide an output that is noticeable as a trend even though a change in a display characteristic in successive representations is not noticeable by the user. Thus, the representations 614(1)-614(K) may be displayed at a rate defined by a just-noticeable threshold such that the individual changes are not noticeable by the user. In the present example, the representation 614 of FIG. 6 may gradually appear to “grow” in the user interface 600 over the period of time “K”.

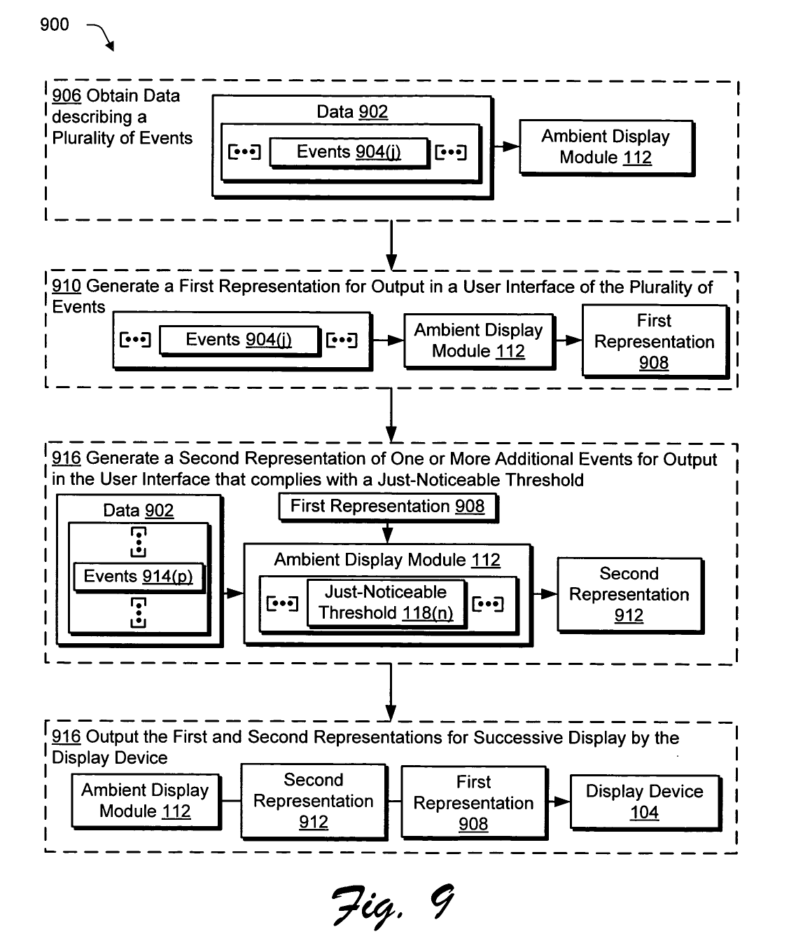

FIG. 8 is an illustration of a system 800 in an exemplary implementation in which a user interface 802 having an ambient display of representations of events is depicted as an island scene on the display device 104. In the previous implementations, user interfaces were shown which employed graphs to arrange representations of events, such as gradients, circles, and so on. The representations, however, may be configured in a wide variety of other ways.

For example, each object in the island scene depicted in FIG. 8 may be configured as a representation of one or more events. The tree 804 may represent email messages received by the computing device 102 of FIG. 1. The height of the tree 804 may be made to vary based on the number of emails messages received. Additionally, leaves 806 of the tree 804 may “grow” or “shrink” based on email messages from particular sources. Thus, the display characteristic “dimension” may be changed for these representations based on the number of email messages received.

Sand 808 on the island 810 may also change texture (e.g., from coarse to fine) based on a number of instant messages received. Thus, the sand 808 provides a representation of events (e.g., number of instant messages received) in the user interface 802 in which the display characteristic “texture” is varied accordingly.

The sun 812 may appear to “move” in the user interface 802 to indicate changes in the stock market. For instance, points in a stock market average may be recognized as events which are utilized to move the sun 812 “upward” in the user interface 802 when the stock market is rising and move the sun 812 “downward” in the user interface 802 when the stock market is falling.

The water 814 may also be configured as a representation. The intensity of the color of the water 814, for instance, may change based on a score in a game, such that as the game becomes closer, the intensity of the color of the water is greater (e.g., brighter blue). Similarly, as the score of the game becomes further apart, the color of the water may have a diminished intensity (e.g., pale blue). Thus, a user glancing at the water 814 is provided with an indication of how “good” a game is being played without having to devote significant cognitive attention by noting changes in the display characteristic “intensity”.

Further, the clouds 816 may also act as a representation of a plurality of events in an ambient display. For example, the user may have a meeting which is scheduled to occur at a predetermined time. As the predetermined time approaches, the clouds 816 may be become larger and darker. Thus, in this example the events may be defined as the minutes remaining until the meeting is scheduled to occur to change the display characteristics “dimension” and “color”. Although a variety of examples of representations were discussed in the forgoing, a wide variety of other representations may be utilized to provide an ambient display.

Exemplary Procedures

The following discussion describes an ambient display that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks.

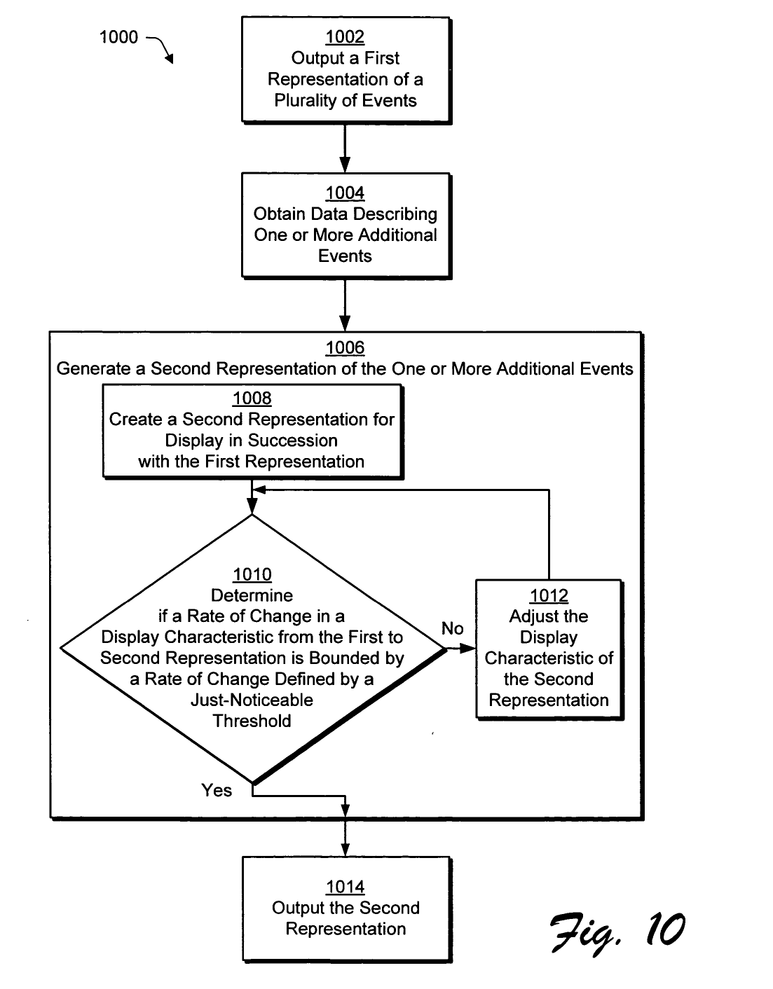

FIG. 9 is a flow diagram depicting a procedure 900 in an exemplary implementation in which first and second representations are generated for successive output in a user interface to provide an ambient display. Data 902 is received by the ambient display module 112 describing a plurality of events 904(j), where “j” can be any integer from one to “J” (block 906). The data 902 may be configured in a variety of ways, such as streaming data (e.g., stock market data, temperatures, and so on), a single file, a collection of documents, and so on.

The ambient display module 112 is executed to generate a first representation 908 for output in a user interface that represents the plurality of events 904(j) (block 910). For example, the representation may be configured as a gradient to describe how the plurality of events 9040) were received over time, may be configured as a collection of representations (such as the circles shown in FIGS. 3-6), as graphical articles as shown in FIG. 8, and so on.

The ambient display module 112 may also be executed to generate a second representation 912 of one or more additional events 914(p), where “p” can be any integer from one to “P” (block 916). The ambient display module 112, for instance, may utilize one or more just-noticeable threshold 118(n) to bound changes made in a display characteristic from the first representation 908 to the second representation 912 so that the fist and second representations 908, 912, when displayed in succession, provide an ambient display representing the pluralities of events 9040), 914(p).

In an implementation, the ambient display module 112 compares the second representation 912 with the first representation 908 to ensure that change(s) made to a display characteristic of the second representation, when output, has a rate of change that matches a rate of change defined by the just-noticeable threshold 118(n). For example, the just-noticeable threshold 118(n) may define a maximum rate of change in the display characteristic “movement” as five pixels-per-second. Therefore, if the first and second representations 908, 912 are to be displayed in succession, one second apart, movement of the second representation 912 with respect to the first representation 908 is bounded by 5 pixels. Rates may also be defined by the just-noticeable thresholds 118(n) for other display characteristics, such as color, dimension, intensity, texture, and so on.

The first and second representations 908, 912 are then output for successive display by the display device 104 (block 916). When displayed, the first and second representations 908, 912 comply with the just-noticeable threshold 118(n) and thus provide an ambient display having representations of the pluralities of events 904(j), 914(p).

FIG. 10 is a flow diagram depicting a procedure 1000 in an exemplary implementation in which a second representation, for output in succession after a first representation, has a display characteristic adjusted for compliance with a just-noticeable threshold. A first representation of a plurality of events is output (block 1002), such as displayed on a display device. Data is obtained which describes one or more additional events (block 1004).

A second representation is then generated which describes the one or more additional events (block 1006). The second representation may be generated in a variety of ways. For example, the second representation may first be created for display in succession with the first representation (block 1008). The second representation, for instance, may be created utilizing a procedure which provides the second representation according to a predetermined formula. A determination is then made as to whether a rate of change in a display characteristic from the first to second representation is bounded by a rate of change defined by a just-noticeable threshold (decision block 1010).

If the rate of change of the representation is not so bounded (decision block 1010), then the display characteristic of the second representation is adjusted (block 1012). For example, the change may have an amount to be displayed during a corresponding period of time (such as a frame display rate of frames having the successive first and second representations). If the rate of change of the representations is not bounded by the rate of change defined by the just-noticeable threshold, the display characteristic of the second representation may be iteratively adjusted until the rate of change of the representations is bounded by the just-noticeable threshold. In another implementation, the adjustment is pre-computed such that a single adjustment is made to the display characteristic of the second representation to comply with the just-noticeable threshold. Once it is determined that the rate of change from the first to second representations is bounded by the just-noticeable threshold (decision block 1010), the second representation is output (block 1014) for display after the output of the first representation (block 1002).

Although adjustment of the display characteristic for the second representation was described in order to ensure that an ambient display was provided, a situation may be encountered in which one or more additional events are received which have an attribute and therefore should not be bounded by the just-noticeable threshold. For example, the computing device 102 may be configured to employ a threshold such that if the number of events is above that threshold, a change is made to the display characteristic that is noticeable to the user. For instance, a network administrator may set the threshold such that if a large number of communications are received which is above the threshold (which may indicate a problem with the network), the administrator is notified immediately. Otherwise, a number of events falling below the threshold may continue to be represented in an ambient display. In another example, events may be “flagged”, such as from a particular contact, such that the user interface represents the event such that it is noticed by the user. A variety of other techniques may also be employed to differentiate events which should be represented in an ambient display from events which should be represented for immediate notice by a user.

FIG. 11 is a flow diagram depicting a procedure 1100 in an exemplary implementation in which streaming data having events that occur at a first rate are represented by successive representations displayed in an ambient display at a second rate which does not match the first rate. Streaming data 1102 is received at a computing device over a period of time 1104 (block 1106). The streaming data 1102 is illustrated in FIG. 11 as a timeline in which each horizontal bar illustrates the occurrence of one of the events during the period of time 1104. Accordingly, the events in the streaming data 1102 have a first rate of occurrence during the period of time 1104 “X”.

The streaming data 1102 is then processed for output in a user interface 1108 as a plurality of representations during a period of time 1110 “Z” (block 1112) at a second rate that is less than the first rate. For example, the horizontal lines of the user interface 1108, which is illustrated as a timeline in FIG. 11, denote when each successive representation that represents the events in the streaming data 1102 is output. However, the streaming data 1102 may provide events at a rate which is greater than the rate, at which, the plurality of representations may be output in the user interface 1108. Therefore, each of the representations may represent two or more of the events, yet still be bounded by a just-noticeable threshold, such that the user interface 1108 is provided with an ambient display of the representations. Although, the second rate was described as less than the first rate, in another implementation, the second rate may be greater than the first rate.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
generating a first representation of a plurality of events for output in a user interface; and
generating a second representation of one or more additional events such that a change made in a display characteristic from the first representation to the second representation complies with a just-noticeable threshold.

2. A method as described in claim 1, wherein the just-noticeable threshold defines a maximum rate of change of the display characteristic to provide an ambient display.

3. A method as described in claim 1, wherein:
the just-noticeable threshold defines a rate of change as an amount of change for the display characteristic during a corresponding period of time; and
the change made to the display characteristic by the amount is not noticeable by a user when displayed over the corresponding period of time.

4. A method as described in claim 1, wherein:
the just-noticeable threshold defines a rate of change as an amount of change for the display characteristic during a corresponding period of time; and
the change made to the display characteristic by the amount is not noticeable by a user when displayed over the corresponding period of time; and
a plurality of said changes are noticeable by the user as a trend.

5. A method as described in claim 1, wherein the display characteristic is selected from the group consisting of:
color;
movement;
intensity;
dimension;
sound;
temperature; and
texture.

6. A method as described in claim 1, wherein the generating of the second representation includes:
creating the second representation;
determining whether the change in the display characteristic from the first representation to the second representation results in a rate of change, when the first and second representations are displayed in succession, that complies with a rate of change defined by the just-noticeable threshold; and
if the rate of change does not comply with the just-noticeable threshold, adjusting the second representation such that the rate of change in the display characteristic of the second representation is bounded by the rate of change defined by the just-noticeable threshold.

7. A method as described in claim 1, wherein:
each said event is described by streamed data;
the plurality of events described by the first representation are received during a first period of time; and
the one or more additional events described by the second representation are received during a second period of time.

8. A method as described in claim 1, wherein the second representation describes the one or more additional events and at least one event from the plurality of events described by the first representation.

9. A method as described in claim 1, further comprising outputting the second representation for display by a display device after the outputting of the first representation to provide an ambient display describing the plurality of events and the one or more additional events.

10. One or more computer readable media comprising computer executable instructions that, when executed on a computer, direct the computer to perform the method of claim 1.

11. A method comprising:
obtaining a data stream describing a plurality of events; and
generating an ambient display having a plurality of representations, wherein:
each said representation represents one or more said events; and
the plurality of representations are displayable in succession such that a rate of change of a display characteristic of successive said representations is bounded by a rate of change defined by a just-noticeable threshold.

12. A method as described in claim 11, wherein:
the rate of change defined by the just-noticeable threshold is an amount of change for the display characteristic during a corresponding period of time; and
a change made to the display characteristic by the amount is not noticeable by a user when displayed over the corresponding period of time.

13. A method as described in claim 11, wherein:
the rate of change defined by the just-noticeable threshold is an amount of change for the display characteristic during a corresponding period of time; and
a change made to the display characteristic by the amount is not noticeable by a user when displayed over the corresponding period of time; and
a plurality of said changes are noticeable by the user as a trend.

14. A method as described in claim 11, wherein the first and second representations, when displayed in succession, provide an ambient display describing the plurality of events and the one or more additional events.

15. A method as described in claim 11, wherein the display characteristic is selected from the group consisting of:
color;
movement;
intensity;
dimension;
sound;
temperature; and
texture.

16. A method as described in claim 11, wherein the generating includes:
creating one said representation for display in succession after a previous said representation;
determining if the rate of change in the display characteristic from the previous said representation to the one said representation is bounded by the rate of change defined by the just-noticeable threshold, and if not, adjusting the display characteristic of the one said representation.

17. A method as described in claim 16, wherein:
the one or more said events described by the previous said representation are received during a first period of time; and
the one or more said events described by the one said representation are received during a second period of time.

18. A method as described in claim 17, wherein the one said representation describes at least one said event described by the previous said representation.

19. A method as described in claim 11, further comprising outputting the plurality of representations in succession for displaying the ambient display.

20. A method as described in claim 11, further comprising:
receiving another event in the data stream; and
generating another representation of the other event, wherein the other representation has a rate of change of the display characteristic that is not bounded by the rate of change defined by the just-noticeable threshold.

21. A method as described in claim 20, further comprising determining whether the other representation has a particular attribute, and if so, performing the generating of the other representation.

22. A method as described in claim 20, further comprising:
determining whether the other representation has a particular attribute, and if so, performing the generating of the other representation; and
the particular attribute is definable by a user.

23. One or more computer readable media comprising computer executable instructions that, when executed on a computer, direct the computer to perform the method of claim 11.

24. One or more computer readable media comprising computer executable instructions that, when executed on a computer, direct the computer to generate an ambient display by:
creating a representation of a plurality of events;
determining if a rate of change in a display characteristic from a previous representation to the created representation is bounded by a rate of change defined by a just-noticeable threshold; and
if the determined rate of change is not bounded the just-noticeable threshold, adjusting the display characteristic of the created representation to provide an ambient display of the created representation and the previous representation.

25. One or more computer readable media as described in claim 24, wherein:
the rate of change defined by the just-noticeable threshold is an amount of change for the display characteristic during a corresponding period of time; and
a change made to the display characteristic by the amount is not noticeable by a user when displayed over the corresponding period of time.

26. One or more computer readable media as described in claim 24, wherein:
the rate of change defined by the just-noticeable threshold is an amount of change for the display characteristic during a corresponding period of time; and
a change made to the display characteristic by the amount is not noticeable by a user when displayed over the corresponding period of time; and
a plurality of said changes are noticeable by the user as a trend.

27. One or more computer readable media as described in claim 24, wherein the previous representation and the created representation are for display in succession to provide the ambient display.

28. One or more computer readable media as described in claim 24, wherein the display characteristic is selected from the group consisting of:
color;
movement;
intensity;
dimension;
sound;
temperature; and
texture.

29. One or more computer readable media as described in claim 24, wherein:
one or more said events described by the previous representation are streamed during a first period of time; and
one or more said events described by the created representation are streamed during a second period of time which is subsequent to the first period of time.

30. A computing device comprising:
a processor; and
memory configured to maintain one or more modules that are executable on the processor to generate an ambient display having a plurality of representations, by:
creating a first said representation for output that describes one or more said events obtained from streaming data during a first period of time;
creating a second said representation for output that describes one or more said events obtained from the streaming data during a second period of time; and
determining if a rate of change in a display characteristic from the first said representation to the second said representation is within a rate of change defined by a just-noticeable threshold, and if not, adjusting the display characteristic of the second said representation.

31. A computing device as described in claim 30, wherein:
the rate of change defined by the just-noticeable threshold is an amount of change for the display characteristic during a corresponding period of time; and
a change made to the display characteristic by the amount is not noticeable by a user when displayed over the corresponding period of time.

32. A computing device as described in claim 30, wherein:
the rate of change defined by the just-noticeable threshold is an amount of change for the display characteristic during a corresponding period of time; and
a change made to the display characteristic by the amount is not noticeable by a user when displayed over the corresponding period of time; and
a plurality of said changes are noticeable by the user as a trend.

33. A computing device as described in claim 30, wherein the first and second representations are for display in succession to provide an ambient display.

34. A computing device as described in claim 30, wherein the display characteristic is selected from the group consisting of:
color;
movement;
intensity;
dimension;
sound;
temperature; and
texture.

35. A computing device as described in claim 30, further comprising:
receiving another event in the streaming data;
determining whether the other event has a particular attribute, and
if the other event has the particular attribute, generating a third representation of the other event, wherein the third representation has a rate of change of the display characteristic that is not bounded by the rate of change defined by the just-noticeable threshold.

36. A system comprising:
means for creating first and second representations for successive output, the first and second representations representing one or more of a plurality events described in data;
means for determining if a change in a display characteristic of the successive representations complies with a just-noticeable threshold; and
means for adjusting the display characteristic of one said representation when the change in the display characteristic between the one said representation and a previous said representation does not comply with the just-noticeable threshold.

37. A system as described in claim 36, wherein:
the rate of change defined by the just-noticeable threshold is an amount of change for the display characteristic during a corresponding period of time; and
a change made to the display characteristic by the amount is not noticeable by a user when displayed over the corresponding period of time.

38. A system as described in claim 36, wherein:
the rate of change defined by the just-noticeable threshold is an amount of change for the display characteristic during a corresponding period of time; and
a change made to the display characteristic by the amount is not noticeable by a user when displayed over the corresponding period of time; and
a plurality of said changes are noticeable by the user as a trend.

39. A system as described in claim 36, wherein the display characteristic is selected from the group consisting of:
color;
movement;
intensity;
dimension;
sound;
temperature; and
texture.

40. A system as described in claim 36, wherein:
one or more said events described by a first said representation are streamed during a first period of time; and
one or more said events described by a second said representation are streamed during a second period of time which is subsequent to the first period of time.
